(19) United States
(12) Patent Application Publication
(10) Pub. No.: US 2026/0253018 A1
(43) Pub. Date: Aug. 27, 2026

(54) PROFICIENCY SUPPORT SYSTEM

(71) Applicant: TOYOTA JIDOSHA KABUSHIKI KAISHA, Toyota-shi (JP)

(72) Inventors: Tomohiro MATSUDA, Toyota-shi (JP); Natsuki FUJII, Nagakute-shi (JP); Tomohiro TSUBOTA, Nagoya-shi (JP)

(73) Assignee: TOYOTA JIDOSHA KABUSHIKI KAISHA, Toyota-shi (JP)

(21) Appl. No.: 19/414,414

(22) Filed: Dec. 10, 2025

(30) Foreign Application Priority Data
Feb. 26, 2025 (JP) 2025-028854

(51) Int. Cl. G06Q 10/0639

(52) U.S. Cl. CPC G06Q 10/06398

(57) ABSTRACT

A proficiency support system that supports the proficiency of a predetermined operation includes an acquisition unit that acquires an operation of an operator that is an object of proficiency support, a recognition unit that recognizes an action of the operator from the acquired operation according to a predetermined classification, a specifying unit that compares a supported worker trajectory that is a transition of a classification of the action of the operator with a proficient worker trajectory that is a transition of a classification of the action of the person who has been proficient in the predetermined operation, and a presentation unit that presents a result of the comparison.

### CROSS-REFERENCE TO RELATED APPLICATION

This application claims priority to Japanese Patent Application No. 2025-028854 filed on February 26, 2025. The disclosure of the above-identified application, including the specification, drawings, and claims, is incorporated by reference herein in its entirety.

### BACKGROUND

### Technical Field

The present disclosure relates to a proficiency support system that assists in acquiring proficiency in a technique.

### Description of Related Art

There has hitherto been known a learning support device that displays work by an expert converted into data as a model movie, in order for an inexperienced worker to efficiently acquire proficiency in the work (see Japanese Unexamined Patent Application Publication No. 2020-144233 (JP 2020-144233 A), for example).

### SUMMARY

However, while such a device may be useful for assisting in learning a technique, the device merely overlaps the actual action by a learning person (hereinafter referred to as a beginner) on the movie as a model. The device does not quantitatively handle the difference between the beginner and the expert. Therefore, it has been difficult to grasp the gap between the beginner and the expert, and to give guidance on what should be improved and to what degree, in order to acquire proficiency.

The present disclosure can be implemented in the following forms or application examples.

(1) A proficiency support system according to an aspect of the present disclosure can be configured as follows. The proficiency support system is a proficiency support system that assists in acquiring proficiency in predetermined work, including: an acquisition unit that acquires action by a worker as a target of proficiency support; a recognition unit that recognizes behavior of the worker from the acquired action according to segments determined in advance;

a specifying unit that makes a comparison between a supported worker trajectory that is a transition of the segments of the behavior of the worker and a proficient worker trajectory that is a transition of the segments of the behavior of a proficient worker that is proficient in the predetermined work; and

a presentation unit that presents a result of the comparison.

In this way, it is possible to allow the supported worker to easily understand the behavior with a low level of proficiency and quantitatively grasp the behavior with a low level of proficiency from the comparison between the trajectories of the segmented behaviors, and thus it is possible to easily achieve support for proficiency.

Such a proficiency support system may further include a learning unit that generates a learning model through supervised machine learning using a recurrent neural network, and the recognition unit may recognize the behavior of the worker using a trained learning model. In this way, the behavior of the worker can be easily recognized according to the segments determined in advance. Such a learning unit may be included in the proficiency support system or may be provided independently of the proficiency support system.

(2) In the above configuration,

the recognition unit may recognize the behavior by associating a label determined in advance with work by the worker; and

the specifying unit may generate the supported worker trajectory according to the label. In this way, by selecting an appropriate label, it is possible to easily grasp the difference between the behavior of the supported worker and the behavior of the proficient worker, and it becomes easy to make improvements toward work proficiency.

(3) In the above configuration (1) or (2),

the label associated with the action by the worker may include a noun that specifies an object to be subjected to the action by the worker, and a verb to which the action belongs; and

the recognition unit may recognize the behavior of the worker according to a combination of the noun and the verb. In this way, it is easier to grasp the details of the work, that is, what to do and how. In addition, it is easy to understand which part has a problem that hinders the supported worker from acquiring proficiency. Therefore, it is also easy to improve the work in which he/she lacks proficiency.

(4) In the above configurations (1) to (3), the proficient worker trajectory may be generated in advance, prior to the comparison by the specifying unit, by acquiring the action by the proficient worker using the acquisition unit and recognizing the acquired action using the recognition unit. In this way, a part of the configuration for acquiring the supported worker trajectory can also be used to acquire the proficient worker trajectory, and the configuration of the proficiency support system can be simplified.

(5) In the above configurations (1) to (4), the result of the comparison may be obtained as a difference for each segment. In this way, the difference between the two can be easily grasped.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a proficiency support system according to a first embodiment;

FIG. 2 is a flowchart showing an operator trajectory generation processing routine;

FIG. 3 is an explanatory view showing a state of generating an operator trajectory;

FIG. 4 is a flowchart showing a task proficiency support routine; and

FIG. 5 is an explanatory diagram illustrating an example of a trajectory between workers and a comparison result thereof.

### DETAILED DESCRIPTION OF EMBODIMENTS

### A. first embodiment

### A1 equipment configuration

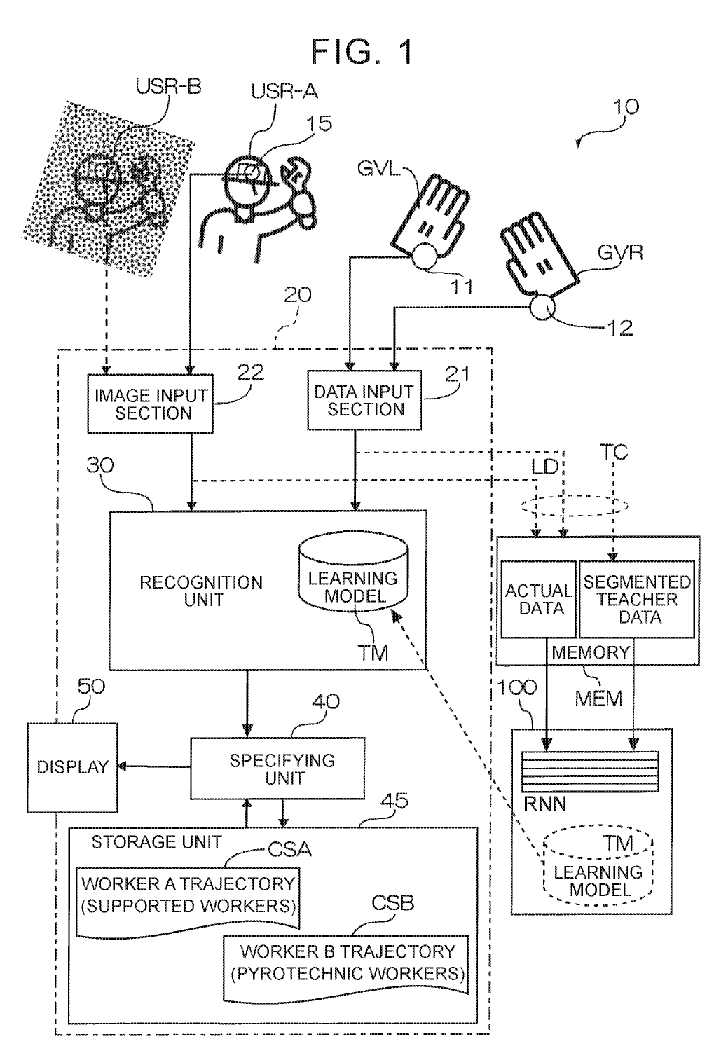

FIG. 1 is a schematic configuration diagram of a proficiency support system 10 according to an embodiment. As illustrated, the proficiency support system 10 performs data processing for proficiency support. The proficiency support system 10 includes a proficiency support device 20 that supports the proficiency of the work of the subject, and a learning device 100 that performs learning such as a classification of the work prior to the support by the proficiency support device 20 to generate a learning model. In addition, the learning model may be generated by the learning device 100 outside the system, and the learning model may be introduced into the proficiency support device 20. The learning device 100 includes a RNN (recurrent neural network) and generates learning model TM. The learning of the learning model TM by the learning device 100 is performed prior to the execution of the support by the proficiency support device 20. Learning of the learning model TM and the like will be described later.

In the proficiency support system 10, an operation or the like of an operator who is not familiar with the work and who intends to familiarize himself/herself with the work using the system is acquired and compared with an operator who has already familiarized with the work. Hereinafter, an operator who is not familiar with the work and who is familiar with the work using the system is referred to as a "supported operator". Hereinafter, an operator who is already familiar with the work is referred to as a "familiar operator". In FIG. 1, for convenience of understanding, the supported worker is shown as a code USR-A, and the skilled worker is shown as a code USR-B. In the explanation of the configuration and the function of the proficiency support system 10, when there is no need to distinguish between them, it is simply referred to as a worker USR.

The proficiency support system 10 includes a proficiency support device 20, work specification sensors 11 and 12 connected thereto, and a wearable camera 15 mounted on a head of a worker USR or the like. In the present embodiment, the work specification sensor 11 is provided in each of a pair of gloves GVL, GVR worn by the worker USR on both hands. The worker USR performs an operation on an object such as a bolt or a nut held via one glove GVL by using a tool or a fixture held via the other glove GVR. The work specification sensors 11 and 12 are used to detect various operations by the worker USR by using pressure, displacement, and the like.

In the present embodiment, an image captured by the wearable camera 15 is also used to detect various operations. The work specification sensors 11 and 12 may be provided only on one of the glove. Instead of the work specification sensors 11 and 12, various operations may be detected by detecting the position and orientation of the hand of the worker USR. In this case, the posture, the position of the fingers, and the like may be recognized from images captured by the wearable camera 15, or a sensor for detecting the position and the movement of the fingers may be provided on the work wear worn by the worker USR. In addition, a mark or a light emitter that is easy to recognize may be provided in the clothing, and the mark or the light emitter may be directly recognized so as to recognize the operation of the worker USR.

The wearable camera 15 mounted on the head of the worker USR always captures an image of basically the line-of-sight of the worker USR, in this case, the vicinity of the hand where various operations are performed. As long as it is possible to capture an image of the hands of the worker USR, that is, the vicinity of the gloves GVL, GVR, a fixed-type camera fixed to a ceiling, a wall, or the like of the workshop may be used. Further, the imaging does not need to be performed at all times, and the imaging may be performed by an instruction from a worker USR or may be performed intermittently, such as every other second, at the beginning of an operation to be mastered.

The signals from the work specification sensors 11 and 12 are input to the data input unit 21 provided in the proficiency support device 20, and the signals from the wearable camera 15 are input to the imaging input unit 22. In the present embodiment, the work specification sensors 11 and 12 and the wearable camera 15 function as an acquisition unit that acquires the behavior of the worker USR, including the data input unit 21 and the imaging input unit 22. Since these data acquired by the acquisition unit are data obtained from the operation of the actual worker USR, both are collectively referred to as an actual data LD. When the proficiency support system 10 supports the proficiency of the worker, the proficiency support device 20 outputs the actual data LD. On the other hand, by using the same device configuration, it is possible to obtain actual data LD from an operation of an operator who has been familiar with the operation, and to use this for machine learning by the learning device 100 which will be described later.

As illustrated in the drawing, the proficiency support device 20 includes a data input unit 21, an imaging input unit 22, a recognition unit 30, a specifying unit 40, a storage unit 45, and a display unit 50. The data input unit 21 receives signals from the work specification sensors 11 and 12. The video signal from the wearable camera 15 is input to the imaging input unit 22. The recognition unit 30 inputs the operation of the worker USR acquired based on the input from the work specification sensors 11 and 12 and the wearable camera 15, and recognizes the behavior of the worker USR using the learning model TM. The recognition unit 30 performs the recognition using the data of the work segment prepared in advance. The data indicating the work category is hereinafter referred to as a label. The label includes a noun specifying an object to which the motion of the worker is performed and a verb to which the motion belongs, and the recognition unit 30 recognizes the behavior of the worker by the combination of the noun and the verb.

The specifying unit 40 stores, in the storage unit 45, the transition of the classification of the behavior of the worker USR recognized by the recognition unit 30, that is, the time series of the classification of the behavior, as a trajectory for each worker. The trajectory for each worker is created and stored for the supported worker USR-A, and the trajectory CSB of the skilled worker USR-B compared with the trajectory CSA of the supported worker USR-A is also stored in the storage unit 45 for comparison. The proficient worker trajectory CSB acquires in advance the behavior of the worker who is familiar with the operation, causes the proficiency support device 20 to recognize the behavior, and further obtains the trajectory, and stores the trajectory in the storage unit 45. The trajectory may be generated by a system or a device different from the proficiency support system 10 illustrated in FIG. 1, and the result may be stored in the storage unit 45.

The storage unit 45 stores CSA of assisted worker trajectory, which is the transition of the classification of the behavior of assisted worker USR-A recognized using the recognition unit 30, and the proficient worker trajectory CSB prepared in advance for the mastery worker USR-B. Then, the specifying unit 40 compares the two. The result of the comparison is displayed on the display unit 50, which is a form of the presentation unit. Here, the presentation of the comparison result is performed by displaying the comparison result on the display unit 50, but it may be performed by audio output, or the comparison result may be presented by printing on a sheet, or may be presented as an operation of a three-dimensional operator model.

### Generate A2 Learn Model TM

The learning model TM used when the recognition unit 30 recognizes the behavior of the worker USR is generated by machine-learning by the learning device 100. For convenience of illustration, the learning device 100 is illustrated in FIG. 1 together with the proficiency support device 20, but the learning device 100 is prepared prior to the process of recognizing the behavior of the supported worker USR-A, and performs machine learning of the learning model TM. The learning device 100 uses a recurrent neural network (RNN) because the data to be handled is time-series data. As shown in FIG. 1, the learning device 100 includes a RNN that performs machine learning, and performs recurrent machine learning by using a large number of actual data LD and teacher data TC relating to classifications of behaviors corresponding to the actual data LD. This learning operation is actually performed prior to comparing the trajectory of the behavior of the supported worker USR-A with the trajectory of the behavior of the skilled worker USR-B.

In the present embodiment, the actual data LD used for the training is time-series data obtained from the above-described work specification sensors 11 and 12 and image data obtained from the wearable camera 15 in time series. For a certain action performed by the worker USR, the actual data LD is inputted, and the teacher data TC is given as a combination of a noun indicating an object of an action and a verb indicating an action, for example, such as "tightening (verb)" of a "bolt (noun)". This allows RNN to be learned so that a large number of behaviors can be partitioned. Note that the term "behavior" is used because there may not exist an object to be operated, such as moving of a worker USR or repeating (naming) of the operation content, and therefore, an operation in which an object to be operated exists and an operation in which it does not exist are included in the expression. When there is no object for such a task, it is handled in a form such as "Null (a noun indicating that the object is empty)" + "move (a verb)", or in a form such as "Null (a noun)" + "name (a verb)".

When the actual data LD is acquired for machine learning, it is sufficient to have the gloves GVL, GVR, the wearable camera 15, the data input unit 21, the imaging input unit 22, and the memory MEM for storing the actual data LD in the illustrated configuration. Work specifications sensors 11 and 12 are mounted on the gloves GVL, GVR. The proficient worker USR-B collects actual data LD as it repeats a particular action. A teacher data TC indicating the behavior when the actual data LD are collected, that is, "motion object (noun)+motion (verb)" is prepared in advance. The teacher data TC and the actual data LD are associated with each other and stored in the memory MEM.

The collection of the actual data LD and the association of the teacher data TC with respect to the behavior of the worker may be performed by one skilled worker USR-B, or may be performed by a plurality of skilled workers. In addition, the gloves GVL, GVR, the work specification sensors 11 and 12, the wearable camera 15, and the like used in the collection of the actual data LD may be the same as those used in the work performed by the supported worker USR-A for proficiency. On the other hand, when the characteristics are the same or similar, different gloves, pressure sensors, and wearable cameras may be used.

### Generation of trajectory of A3 supported worker

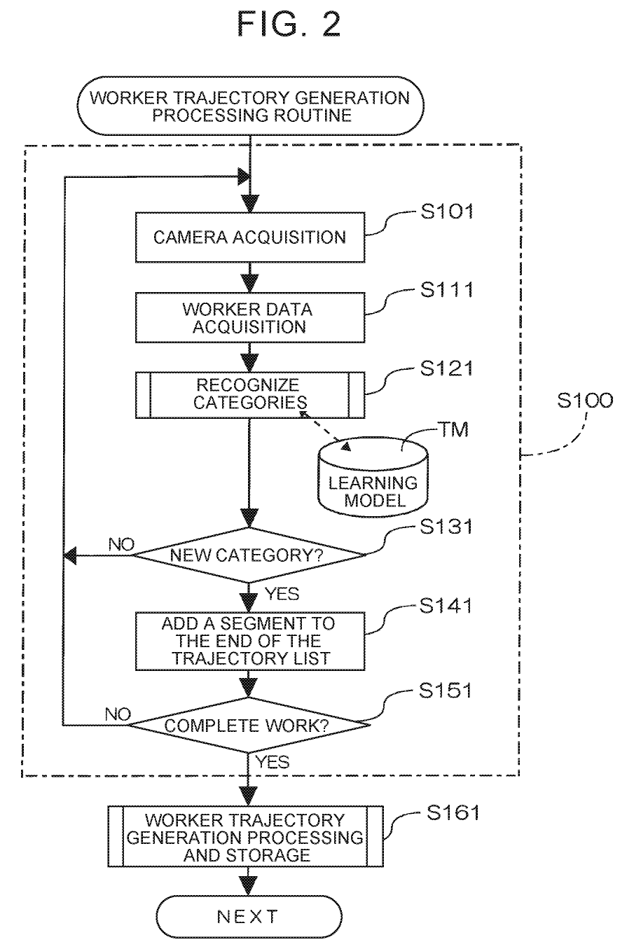

Next, a process of generating a trajectory at the time of operation of the supported worker USR-A in need of support for proficiency will be described with reference to FIG. 2. FIG. 2 is a flowchart illustrating a process performed by the proficiency support device 20. This process is executed when the supported worker USR-A starts the work, and first acquires images from the wearable camera 15 (S101), and then acquires data related to the operation of the worker USR from the work specification sensors 11 and 12 (S111). That is, the actual data LD of the worker is inputted in time series.

Next, a process of recognizing the classification of the behavior of the worker USR is performed by referring to the learning model TM using the actual data LD (S121). When the worker USR performs the action of, for example, tightening the bolt R, the operator determines the start to the end of the series of actions as one segment. This determination can be easily realized by the learning model TM learned in advance using RNN.

Next, by the determination using the learning model TM, it is determined whether or not a new segment has been formed by adding a segment of one behavior (S131). When it is not determined that a new category has been established (S131: "NO"), the process returns to S101, and the process is repeated. On the other hand, when it is determined that the behavior of the worker USR has become a new category (S131: "YES"), a process of adding the previous segment recognized in step 121 to the end of the trajectory list is performed (S141).

In other words, the operation of the worker USR is analyzed in time series by the actual data LD, for example,

Bolt R + Tightening

Connector E + mating

Jig X + rotation

As described above, the operations performed by the worker USR are classified into a single group as an object (noun) + an operation (verb), and these operations are listed in time series. This list is referred to as an "operator trajectory" or simply as a "trajectory list". In the output stage of the recurrent neural network RNN, the output of the object and the operation is prepared, and the learning result is learned in accordance with the teacher data TC, thereby completing the learning (generalization) of the classification.

According to the actual data LD, the behavior of the worker USR is classified, and after adding the previously recognized behavior to the end of the trajectory list, it is determined whether all the operations of the worker USR have been completed (S151). When you are still working (S151: "NO"), the process is repeated from S101. The processes up to this point (S101 to S151) will be referred to as a behavior recognition process (S100). By repeating S151 from S101, the behavior of the worker can be recognized as an object (noun)+motion (verb) as described above.

When it can be determined in S151 that all operations have been completed (S151: "YES"), the trajectory listing is closed. When the generation process of the worker trajectory is completed, the worker trajectory (trajectory list) is stored in the storage unit 45, and this processing routine is ended.

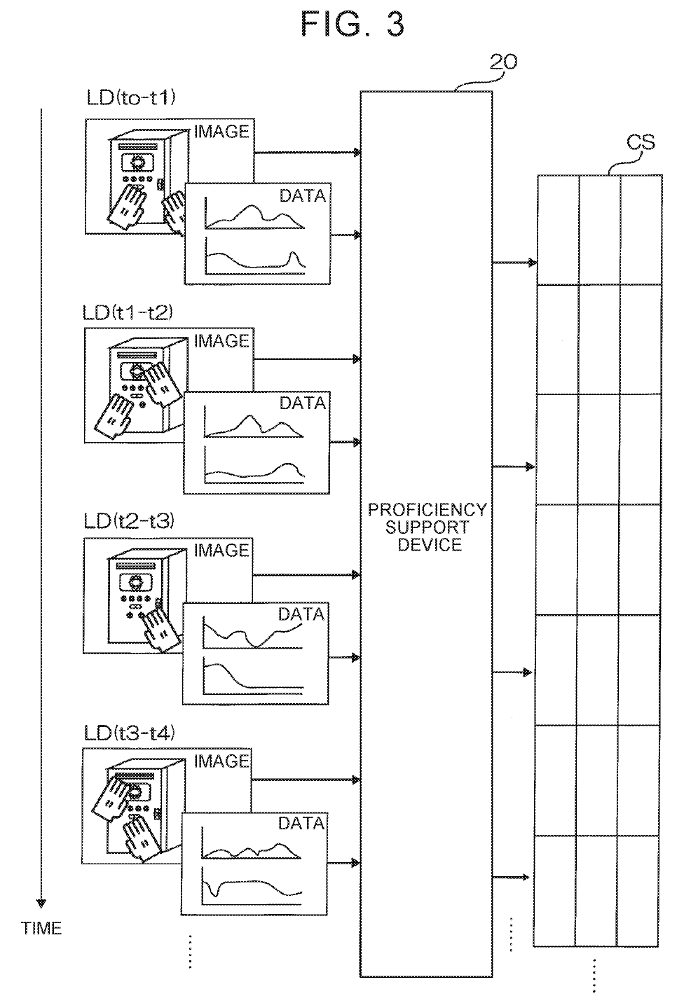

The above processing is schematically illustrated in FIG. 3. The actual data LD is sequentially inputted to the proficiency support device 20 along the hour, and the proficiency support device 20 sequentially recognizes the behavior of the worker USR and adds this to the trajectory list CS. Such a process does not change even when the worker is a supported worker USR-A who is not familiar with the work or a USR-B of familiar workers who are familiar with the work. Therefore, it is also easy to prepare the proficient worker trajectory CSB for the proficient worker USR-B in advance.

### Handling to assist with A4 proficiency

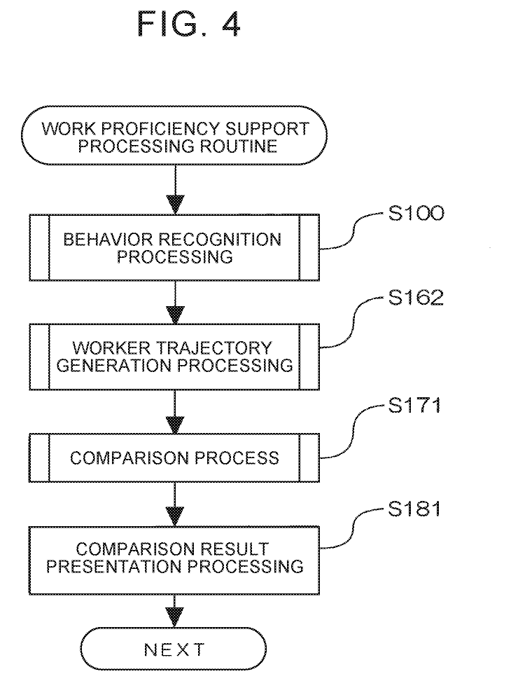

Next, a process of assisting USR-A of the supported worker in familiarization will be described. FIG. 4 is a flowchart illustrating a mastery support process for a supported worker USR-A. When this processing routine is started, first, S100 processing of the worker trajectory generation processing routine illustrated with reference to FIG. 2, that is, the processing of recognizing the behavior of the worker, is performed with respect to the supported worker USR-A. Consequently, since the behavior of the supported worker USR-A is recognized, a worker trajectory in which the recognized behavior categories are arranged in time series is next generated (S162). This process is a process corresponding to S161 of FIG. 2, and in FIG. 2, a worker is not identified, whereas in this case, a worker is identified to be a supported worker USR-A that receives proficiency support.

After the supported worker trajectory is stored in the storage unit 45, a process of comparing the trajectory CSA of the supported worker USR-A with the trajectory CSB of the skilled worker USR-B is performed (S171), and a process of presenting the result of the comparison is performed (S181). Thus, the work skill support process is completed.

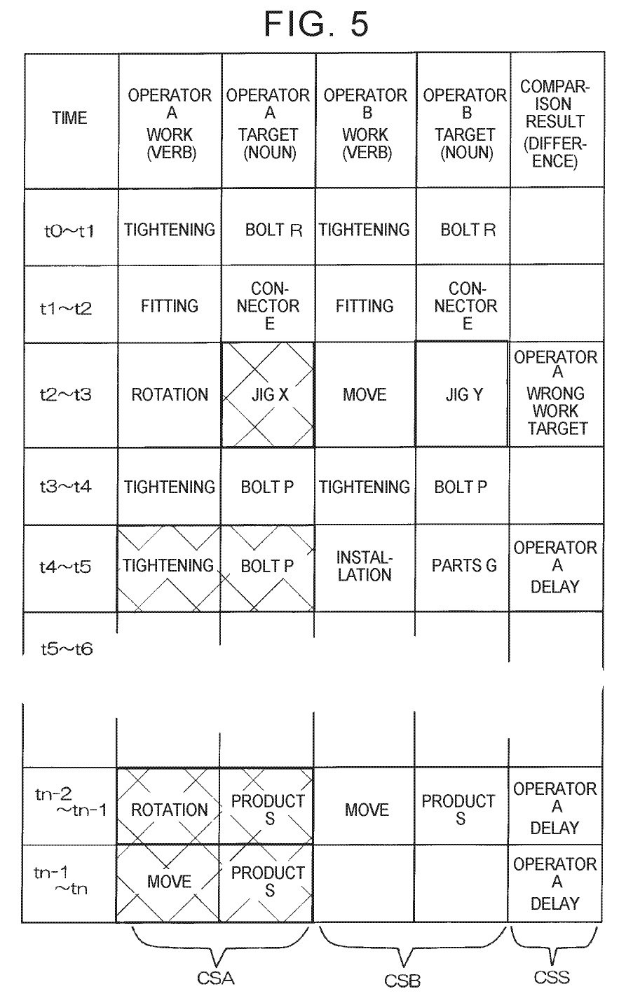

FIG. 5 shows a comparison (S171) of trajectories in the operation skill support process and a presentation (S181) of comparison results. In the drawing, the trajectory CSA is a time-series arrangement of the behavior of the worker A. The worker A is a supported worker USR-A. On the other hand, the trajectory CSB is obtained by arranging the behavior of the worker B, that is, the skilled worker USR-B, in time series. FIG. 5 compares the trajectories of the two in time series, and a comparison result is shown at the right end of the trajectory. The trajectory and the comparison result are displayed on the display unit 50.

In this embodiment, during a period from the time t0 at which the work is started to the time t1, both the worker A and the worker B perform the same behavior, that is, the work of tightening the bolt R. For this reason, the comparison result (difference) column is blank, or an evaluation such as "same" is displayed corresponding to the evaluation. Similarly, from the time t1 to t2, the worker A, B performs the operation of fitting the connector E together, and there is no indication regarding the difference in the comparison-result column.

However, from the time t2 to t3, the worker A takes a behavior of rotating the jig X, whereas the worker B takes a behavior of rotating the jig Y, and the behavior of both is different. Therefore, in the column of the comparison result, the difference between the two is displayed as the "work target error". With regard to the work shown by hatching in the figure, it is determined that the work of the worker A is somewhat different from the work of the worker B. Here, it is pointed out that the behavior of the worker A is mistaken for the object to be worked.

Further, the worker A takes the action of tightening the bolt P from the time t3 to t5, which is different from the operation of the worker B in the following points. Although the worker B takes the action of tightening the bolt P in the same manner from the time t3 to t4, the worker B takes the following action from the time t4 to t5, that is, attaching the component G. Therefore, the time t4 is compared with t5 to indicate "worker A work delay".

The delay of the work by the worker A caused in t5 from the time t4 has not been eliminated until the time tn of the completion of the series of works in the drawing. For this reason, during the period from t5 to tn, similar indications are displayed in the comparative outcome column. Usually, it is difficult to eliminate such delays, although it is difficult to solve such delays. However, when Operator A, at any point in time, advances the work and catches up with Operator B's work, the indication of delays in the work will be eliminated.

According to the proficiency support system 10 of the present embodiment described above, it is possible to quantitatively indicate, to the proficient worker USR-B who is familiar with the work, in which point the work of the supported worker USR-A who is not familiar yet is not familiar. It can be quantitatively shown in accordance with the details of the specific work such as the difference in the behavior and the delay.

For this reason, the assisted worker USR-A can easily work on improving his/her own work by using the proficiency support system 10. It is easy to improve erroneous operation, delay of operation, and the like because it is possible to grasp specifically what kind of operation is problematic with respect to an object of work in which scene, rather than simply delaying the work. In addition, it is easy to instruct the assisted worker USR-A to increase the proficiency level of the operation.

First, a work on an object or an object to be worked is recognized, and this is shown as a trajectory. Therefore, for example, when the object of the operation is wrong, it is easy to understand the points to be improved for the proficiency, such as whether there is a simple error, for example, whether there is a high frequency of mistake of the "bolt", and whether there is a problem in the identification of the bolt. Similarly, for example, it is possible to grasp a characteristic of a behavior in which a work delay is likely to occur, and to strive for improvement.

In each of the above-described embodiments, a part of the configuration realized by hardware may be replaced with software. At least a part of the configuration realized by the software may be realized by a discrete circuit configuration. In addition, when some or all of the functions of the present disclosure are realized by software, the software (computer program) can be provided in a form stored in a computer-readable recording medium. The "computer-readable recording medium" is not limited to a portable recording medium such as a flexible disk or a CD-ROM. The "computer-readable recording medium" also includes an internal storage device in a computer such as various RAM and ROM, and an external storage device fixed to a computer such as a hard disk. In other words, the term "computer-readable recording medium" has a broad meaning including any recording medium capable of fixing data packets rather than temporarily.

The present disclosure is not limited to each of the above embodiments, and can be realized by various configurations without departing from the spirit thereof. For example, the technical features of the embodiments corresponding to the technical features in the respective embodiments described in the Summary of the Disclosure can be appropriately replaced or combined in order to solve some or all of the above-described problems. Alternatively, for example, the technical features of the embodiments corresponding to the technical features in the respective embodiments described in the Summary of the Disclosure can be appropriately replaced or combined in order to achieve some or all of the above-described effects. Further, when the technical features are not described as essential in the present specification, these can be deleted as appropriate. For example, a part of the configuration realized by hardware in the above-described embodiment can be realized by software.

What is claimed is:

1. A proficiency support system that assists in acquiring proficiency in predetermined work, comprising:
an acquisition unit that acquires action by a worker as a target of proficiency support;
a recognition unit that recognizes behavior of the worker from the acquired action according to segments determined in advance;
a specifying unit that makes a comparison between a supported worker trajectory that is a transition of the segments of the behavior of the worker and a proficient worker trajectory that is a transition of the segments of the behavior of a proficient worker that is proficient in the predetermined work; and
a presentation unit that presents a result of the comparison.

2. The proficiency support system according to claim 1, wherein:
the recognition unit recognizes the behavior by associating a label determined in advance with work by the worker; and
the specifying unit generates the supported worker trajectory according to the label.

3. The proficiency support system according to claim 2, wherein:
the label associated with the action by the worker includes a noun that specifies an object to be subjected to the action by the worker, and a verb to which the action belongs; and
the recognition unit recognizes the behavior of the worker according to a combination of the noun and the verb.
